(19) United States
(12) Patent Application Publication
(10) Pub. No.: US 2015/0081433 A1
(43) Pub. Date: Mar. 19, 2015

(54) SELECTION AND COMMUNICATION OF A PRODUCT PROMOTION

(71) Applicant: Wal-Mart Stores, Inc., Bentonville, AR (US)

(72) Inventor: Valerie Goulart, Seattle, WA (US)

(73) Assignee: Wal-Mart Stores, Inc., Bentonville, AR (US)

(21) Appl. No.: 14/030,773

(22) Filed: Sep. 18, 2013

(51) Int. Cl. G06Q 30/02; G06Q 30/06

(52) U.S. Cl. CPC G06Q 30/0255; G06Q 30/0633
USPC 705/14.53

(57) ABSTRACT

A disclosed method stores identities of a plurality of products offered for sale in a product database. Each identity is correlated to historical information detailing consumers' interest in the product. The method also receives a shopping request signal from an electronic computing device operated by a first consumer shopping for at least one of the products offered for sale. The method further maintains a shopping cart for the first consumer such that one or more of the products offered for sale can be cataloged for the first consumer until purchase. Additionally, the method may transmit a product promotion signal to the electronic computing device over a network. The product promotion signal contains data associated with a first product. The method also selects the first product for inclusion in the promotion signal in response to the historical information stored in the product database.

### BACKGROUND INFORMATION

1. Field of the Disclosure

The present invention relates generally to optimizing the delivery of product promotions to consumers. In particular, examples of the present invention are related to techniques for selecting one or more product promotions for communicating to a consumer.

2. Background

Product promotions can be delivered in print, audio and video formats. A product promotion can be a notice of a sale, a coupon, a price rollback, or notice of some other attribute of the product that increases the desirability of the product to a consumer. Promotions can encourage consumers to try new products. Promotions can also entice consumers to purchase products that may not be needed. From the customer's perspective, seeking promotions can have drawbacks. For example, collecting coupons or searching through sale announcements can require a significant investment of time. This occurs because attractive promotions are usually contained within a bundle of promotions, wherein the majority of promotions are not relevant to the consumer. The time required to search for a few relatively desirable promotions can thus deter consumers from taking advantage of product promotions and can sour the consumer's perspective on promotions generally.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is an example schematic illustrating a system according to some embodiments of the present disclosure.

FIG. 2 is an example block diagram illustration of a commerce server that can be applied in some embodiments of the present disclosure.

FIG. 3 is an illustration of an operating environment according to some embodiments of the present disclosure.

FIG. 4 is an example flow chart illustrating a method that can be carried out according to some embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Embodiments of the present disclosure can enhance a retailer's ability to determine the best time to merchandise or promote specific products to specific consumers. Systems according to some embodiments of the present disclosure can be applied to predict what consumers might be interested in purchasing a product or placing a product in a shopping cart. A system according to some embodiments of the present disclosure can collect information about purchases and occurrences of a product being placed in an electronic shopping cart. With this data, the system can present relevant product promotions to consumers. For example, products that are regularly purchased at a particular time of day or placed in a shopping cart on a particular day of the week can be promoted to consumers shopping at those times or on those days. Other categories of data can be collected and considered when determining what products are to be promoted, such as weather and geographical regions of purchases and cart placement.

The data that can be collected for each purchase can also be collected when products are added to an electronic shopping cart. Collectively, these events can be designated as consumer interest events. For example, it may be determined from data that televisions are most likely added to a shopping cart on Wednesday evenings but are mostly purchased on Saturday afternoons. In some embodiments of the present disclosure, product promotions for televisions can be transmitted to consumers shopping on Wednesday afternoons and evenings as well as Saturday mornings and afternoons.

Promotions can be transmitted to electronic computing devices being operated by consumers. An electronic computing device operated by a consumer can be a laptop computer, a desktop computer, a smart-phone, a tablet, an e-reader, or any other electronic computing device operable to receive and transmit video and audio data associated with shopping.

Consumers would benefit from systems according to at least some embodiments of the present disclosure in that more relevant product promotions would be received a fewer less relevant promotions would have to be considered. Retailers and merchants would benefit because the likelihood of a consumer purchasing products would increase. Systems according to at least some embodiments of the present disclosure can store data associated with particular consumers. For example, the purchasing history for a consumer can be retained as well as the history of a consumer's placement of products in an electronic shopping cart. Thus, data associated with consumer interest events can be stored and correlated to products and to particular consumers. For example, a purchase by a first consumer of product “A” would be stored in a product database and correlated to product “A.” The data in the product database could include that product “A” was purchase by the first consumer (precisely identified), the purchase time, the date, and one or more demographics of the first consumer. The same data can be stored in a consumer database and correlated to the first consumer.

The system can weigh the consumer's personal purchase history more than the product data, which would be associated with consumers generally. For example, data in a consumer database may indicate that a particular consumer may tend to buy walnuts on Mondays in December. But the data associated with walnuts in a product database tends to indicate that consumers generally tend to purchase walnuts on Fridays in November. A system according to an embodiment of the present disclosure can send promotions related walnuts to the particular consumer on Mondays in December even though this would not be consistent with data in the product database. The promotion could none the less be sent because it is consistent with data associated with the particular consumer in the consumer database.

Systems according to at least some embodiments of the present disclosure can dynamically present product promotions to customers based on the time of day, popularity (products that are currently being purchased in relatively large quantities), historical data of products that were popular the same day and/or time in past years, or all of the above based on a certain region of the country or the world.

Systems according to at least some embodiments of the present disclosure can update in real time based on products that are trending and have trended previously based on historical data. The promotions can be transmitted to a mobile device or website in a banner-style ad or in a simple product carousel that updates automatically. For example, the transmitted promotion(s) could appear on the viewing screen of a consumer's electronic computing device before the retailer's website is displayed. The consumer can be given the opportunity to learn about a promotion or reject the promotion and proceed to view all products offered for sale by the retailer. Also, in a subtle and possibly more effective manner, a system according to at least some embodiments of the present disclosure could be applied to determine the display of products on a physical shelf in a retail store.

Systems according to at least some embodiments of the present disclosure can determine when a consumer is purchasing a product or merely placing a product in the shopping cart. For example, if it is determined that most consumers or a particular consumer place orders between 8-9 p.m., more product promotions directed to lower-priced impulse items can be transmitted at that time because consumers may be more willing to add those products as last minute impulse buys.

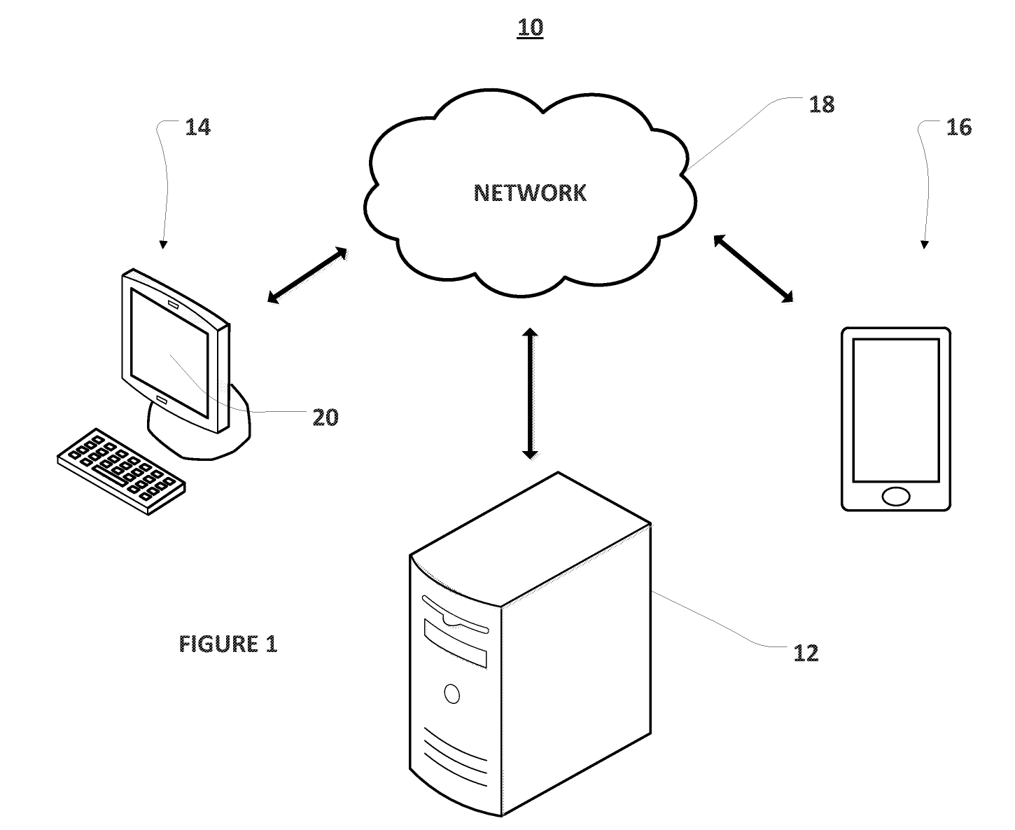

FIG. 1 is a schematic illustrating a product promotion system 10 according to some embodiments of the present disclosure. The product promotion system 10 can execute a computer-implemented method that includes the step of storing identities of a plurality of products offered for sale in a product database. Each identity can be correlated to historical information detailing consumers' interest in the product. The database can be contained in a commerce server 12 or accessed by the commerce server 12 in various embodiments of the present disclosure.

The commerce server 12 of the product promotion system 10 can receive a shopping request signal from an electronic computing device operated by a first consumer shopping for at least one of the plurality of products offered for sale. FIG. 1 shows a first exemplary electronic computing device 14 and a second exemplary electronic computing device 16 communicating with the commerce server 12 over a network 18. The exemplary first electronic computing device 14 can be a desktop computer. The exemplary second electronic computing device 16 can be a smart phone. The first consumer can be operating either of the first or second electronic computing devices 14 or 16, or another form of electronic computing device, but will be presumed to be using the electronic computing device 14 in this description. The shopping request signal can be defined by a request to access a retailer's website. When a consumer attempts to access the retailer's website, the commerce server 12 can recognize this attempt as a shopping request signal. Other forms of shopping request signals can be received in other operating environments in which some embodiments of the present disclosure can be practiced.

Signals transmitted by the first and second electronic computing devices 14, 16 and received by the commerce server 12, and vice-versa, can be communicated over the network 18. As used herein, the term “network” can include, but is not limited to, a Local Area Network (LAN), a Metropolitan Area Network (MAN), a Wide Area Network (WAN), the Internet, or combinations thereof. Embodiments of the present disclosure can be practiced with a wireless network, a hard-wired network, or any combination thereof.

The commerce server 12 can maintain a shopping cart for the first consumer. One or more of the plurality of products offered for sale can be cataloged for the first consumer in the shopping cart until purchase. The shopping cart can be accessible to fill or empty by the first consumer through the electronic computing device 14. An icon or visible indicia can be viewable on the screen of the consumer's electronic computing device 14 and the consumer can select or click on this icon to access the contents of the shopping cart.

In response to receiving the shopping request signal, the commerce server 12 can transmit a product promotion signal to the electronic computing device 14 over the network 18. The product promotion signal contains data associated with a first product from among the plurality of products offered for sale. The data contained by the product promotion signal tends to enhance the desirability of the first product for the first consumer. For example, the data can indicate that the first product is on sale or has been improved or is organic, or any other information that may be of interest to the first consumer. The product promotion signal can contain data associated with more than one of the plurality of products offered for sale.

The product promotion signal can be processed by the electronic computing device 14 and result in a product promotion being displayed on a display 20 of the electronic computing device 14. The product promotion(s) may occupy any portion of the display 20 and may occupy less than all of the display 20.

The commerce server 12 can select the first product for inclusion in the promotion signal in response to the historical information stored in the product database. The historical information can detail consumers' interest in the first product. Consumers' interest can be defined by the number of past events in which some consumer has purchased the product or has placed the product in the shopping cart. Each of these events can encompass a subset of data, such as a specific time, a date, a day of the week, a geographic region of the consumer, a gender or age of the consumer, the weather the consumer was experiencing, and any other category of data that can be relevant to consumer purchasing habits. The data associated with each of these prior consumer interest events can be stored in a product database and correlated to one or more specific products. The data associated with each of these prior consumer interest events can also be stored in a consumer database and correlated to one or more specific consumers.

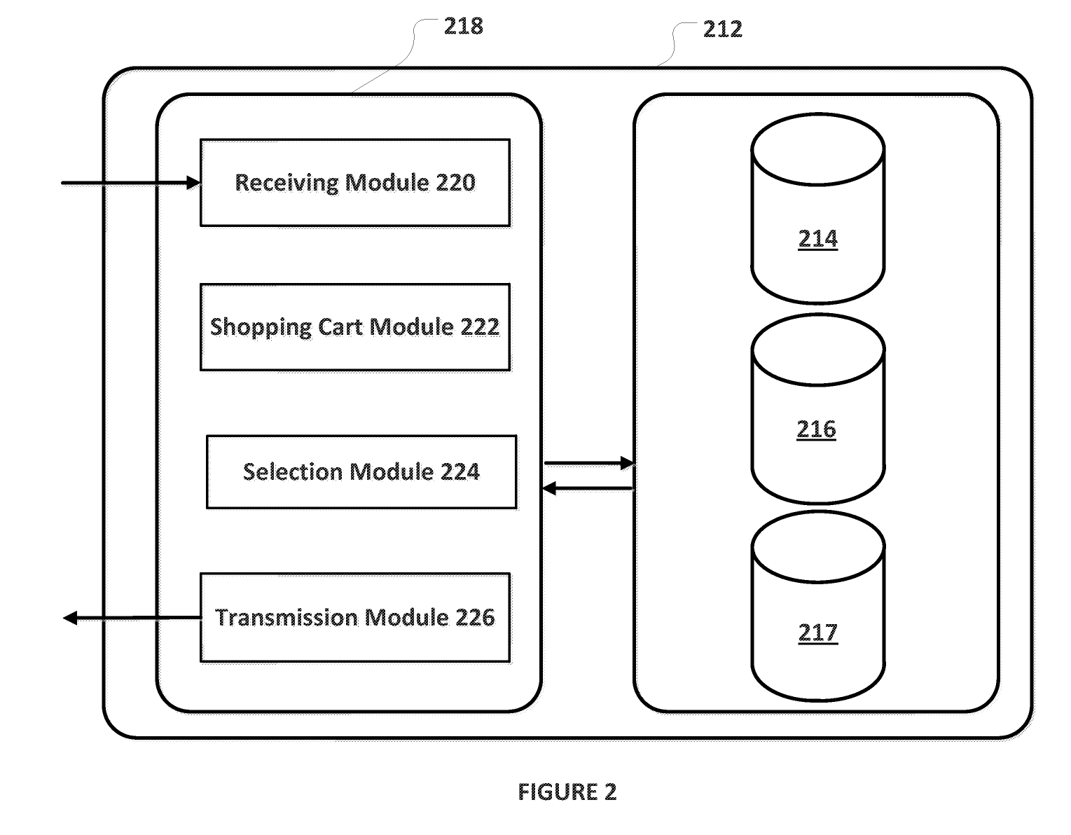

FIG. 2 is a block diagram illustrating a commerce server 212 according to some embodiments of the present disclosure. In the illustrated embodiment, the commerce server 212 can include a product database 214, a consumer database 216, and a product promotion database 217. The commerce server 212 can also include a processing device 218 configured to include a receiving module 220, a shopping cart module 222, a selection module 224, and a transmission module 226.

Any combination of one or more computer-usable or computer-readable media may be utilized in various embodiments of the disclosure. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

The product database 214 can contain the identities of a plurality of products offered for sale by a retailer. Each identity can be correlated to historical information detailing consumers' interest in the product. Consumers' interest in the product can be quantified by previous purchases of the product and past occurrences of the product being placed in the shopping cart. Each previous purchase can be stored in the product database 214 and correlated to one or more products and each previous purchase can be defined by a subset of data. The subset of data can include any category of data that may be relevant to consumers' interest in the product. For example, each previous purchase can be defined in part by a time of purchase, by the day of the week, and by the date (month and year). Also, in some embodiments, additional data can associated with each purchase such as the geographic location of the consumer or other consumer demographic data, such as age or gender. The same categories data can be stored in the product database 214 and be associated with occurrences of a product being placed in the shopping cart. The data in the product database 214 can be organized based on one or more tables that may utilize one or more algorithms and/or indexes.

The consumer database 216 can include in memory the identities of a plurality of consumers. The plurality of consumers can be the consumers who have purchased items in one or more retail stores that are associated with the commerce server 212. The consumer database 216 can also contain the purchase histories of each consumer. The data in the consumer database 216 can be organized based on one or more tables that may utilize one or more algorithms and/or indexes.

The same categories data stored in the product database 214 and associated with purchases and placements of a product in a shopping cart can also be stored in the consumer database 216 and associated with one or more consumers. Data can be retained in the consumer database 216 for purchases and also for occurrences of the consumer placing a product in the shopping cart. For example, a male consumer aged thirty-five can access a retailer website with a desktop computer located in Utah and purchase a brand “A” television from the retailer. The purchase can occur at 6:30 p.m. on Saturday, May 3. This event can result in the data associated with the brand “A” television in the product database 214 being updated to reflect another purchase of the brand “A” television. The subset of data associated with this purchase can include, by way of example and not limitation, a male purchaser, a purchaser aged thirty-five, a purchaser from Utah, a purchase at 6:30 p.m., a purchase on Saturday, and a purchase on May 3. If the male consumer placed the brand “A” television in the shopping cart at 6:00 p.m., this information can also be included in the subset of data. If the identity of the consumer is known, this information can also be included in the subset of data. All of this information can be stored in the product database 214 and associated with the brand “A” television. Further, all of this information can also be stored in the consumer database 216 as an entry with a subset of data categories, wherein the entry is associated with the male consumer. The identity of the male consumer would be the primary category of data in the consumer database 216 as the brand “A” television can be the primary category of data in the product database 214. The purchase, defined by a subset of data, can be a secondary category of data in both databases 214, 216.

The product promotion database 217 can include memory containing product promotions associated with one or more of the plurality of products stored in the product database 214. The product promotions can be defined by video data, audio data, and/or text data. The product promotions can be located within the product promotion database 217 and can be organized based on one or more tables that may utilize one or more algorithms and/or indexes.

The processing device 218 can communicate with the databases 214, 216, 217 and receive one or more signals from electronic computing devices, such electronic computing devices 14, 16. The processing device 218 can include computer readable memory storing computer readable instructions and one or more processors executing the computer readable instructions.

The receiving module 220 can be operable to receive signals over the network 18, assess the signals, and communicate the signals or the data contained in the signals to other components of the commerce server 212. The receiving module 220 can be configured to receive signals from one or more consumers indicating a desire to place a product in the shopping cart. The receiving module 220 can receive such a signal and direct the signal to the shopping cart module 222 for further processing, as will be discussed in greater detail below. The receiving module 220 can also be configured to receive shopping request signals from one or more consumers operating respective electronic computing devices. The receiving module 220 can receive a shopping request signal and direct the shopping request signal to the selection module 224 for further processing, as will be discussed in greater detail below.

The shopping cart module 222 can be operable to maintain a shopping cart for the first consumer. One or more of the plurality of products offered for sale can be cataloged for the first consumer in the shopping cart until purchase. When a product is placed in the shopping cart, the shopping cart module 222 can be operable to update data associated with that product in the product database 214 to reflect that the product was placed in the shopping cart.

The selection module 224 can be configured to act on shopping request signals received from consumers. In response to a shopping request signal received from the receiving module 220, the selection module 224 can first recognize a time of receipt of the shopping request signal (the commerce server can inherently include a clock). The selection module 224 can also recognize a date of receipt of the shopping request signal. The selection module 224 can also recognize other categories of data that might be associated with the receipt of the shopping request signal, such as the day of the week and the geographic location association with the origin of the shopping request signal. The selection module 224 can also attempt to determine an identity of the first consumer, the consumer who initiated the shopping request signal. The signal received from the electronic computing device 14 can include a digital identification code, such as a Media Access Control (MAC) address. If the consumer can be identified, the selection module 224 can access the consumer database 216 and retrieve data associated with the consumer, such as demographic data, purchase history data, and data revealing the consumer's previous placements of products in a shopping cart.

The selection module 224 can access and search the product database 214 after accumulating the data that can be acquired about the shopping request signal. The selection module 224 can access and search the product database 214 and determine what products are most often purchased at the time of receipt of the current shopping request signal. The selection module 224 can access and search the product database 214 and determine what products are most often purchased on the date of receipt of the current shopping request signal, or the day of the week. The selection module 224 can access and search the product database 214 and determine what products are most often purchased at the time and on the date of receipt of the current shopping request signal. The selection module 224 can access and search the product database 214 and determine what products are most often purchased for any category of data retained in the product database 14 and for any combination of data categories. The selection module 224 can take the same approach for data associated with occurrences of a consumer placing an item in a shopping cart. If the consumer's identity was determined, the selection module 224 can access and search the product database 214 and determine what products are most often purchased for any category of data associated with the consumer, such as gender, age and physical location.

The selection module 224 can also access and search the consumer database 216 after accumulating the data that can be acquired about the shopping request signal. The selection module 224 can access and search the consumer database 216 and determine what products are most often purchased by the first consumer at the time of receipt of the current shopping request signal. The selection module 224 can access and search the consumer database 216 and determine what products are most often purchased by the first consumer on the date of receipt of the current shopping request signal, or the day of the week. The selection module 224 can access and search the consumer database 216 and determine what products are most often purchased by the first consumer at the time and on the date of receipt of the current shopping request signal. The selection module 224 can access and search the consumer database 216 and determine what products are most often purchased by the consumer for any category of data retained in the product database 14 and for any combination of data categories. The selection module 224 take the same approach for data associated with occurrences of the first consumer placing an item in a shopping cart. A product selected by the selection module 224 can be designated as a “current product” and the selection module 224 can define or designate the current product as the “first product” for promotion to the consumer.

Upon searching the product database 214 and/or the consumer database 216, the selection module 224 can select a first product that the first consumer may desire to purchase or may be inclined to place in the shopping cart. In some embodiments of the present disclosure, the selection module 224 can operable to select more than one product, such as a first product, a second product, a third product, and a fourth product. In some embodiments of the present disclosure, the selection module 224 can operable to select more than four products.

The selection module 224 can select the product in the product database 214 that has been most often purchased at the time of receipt of the shopping request signal, or most often placed in a shopping cart at the time of receipt, or most often purchased on the date of receipt, or most often placed in a shopping cart on the date of receipt. The selection module 224 can apply a nested filtering approach, such as selecting the product most often purchased at the time and date of receipt of the shopping request signal. More than two levels of filtering can be applied in embodiments of the present disclosure. For example, the selection module 224 can select the product most often placed in a shopping cart at the time and date of receipt of the shopping request signal, by a consumer of the same age and gender as the current consumer, and from the same geographical region as the current consumer.

The selection module 224 can also be configured to select a first product that the particular consumer, the first consumer, may desire to purchase or may be inclined to place in the shopping cart from the consumer database 216. The first consumer may have demonstrated historically that groceries are placed in a shopping cart every Thursday evening for example. If the shopping request signal is received from the first consumer on Thursday morning or afternoon, the selection module 224 can select a grocery product as the first product to promote to the consumer.

In some embodiments, the selection module 224 can select multiple products to promote to the consumer. For example, the selection module 224 can select the product in the product database 214 that has been most often purchased at the time of receipt of the shopping request signal as the first product, the product most often placed in a shopping cart at the time of receipt as a second product, the product most often purchased by the current consumer on the day of the week of receipt as a third product, and the product most often placed in a shopping cart by the current consumer on the date of receipt as a fourth product. The first, second, third, fourth products can be jointly selected for promotion to the first consumer.

After selecting one or more products, the selection module 224 can access the product promotion database 217 and retrieve any product promotions for the product(s) selected. In the example set forth above, the selection module 224 could retrieve a first product promotion associated with the first product, a second product promotion associated with the second product, a third product promotion associated with the third product, and a fourth product promotion associated with the fourth product.

The selection module 224 can also be configured to determine if the first consumer, the current consumer, will purchase the first product or place the first product in the shopping cart without purchasing the product. This can be determined by comparing the consumer's previous activity at the time of receipt of the current shopping request signal, the date, the day of week, or any other category of data.

After selecting one or more products and retrieving relevant product promotions, the selection module 224 can direct the transmission module 226 to transmit a product promotion signal to the electronic computing device 14. The product promotion signal transmitted can contain the product promotion(s) available for the product(s) selected by the selection module 224 as being the most likely products of interest to the current consumer.

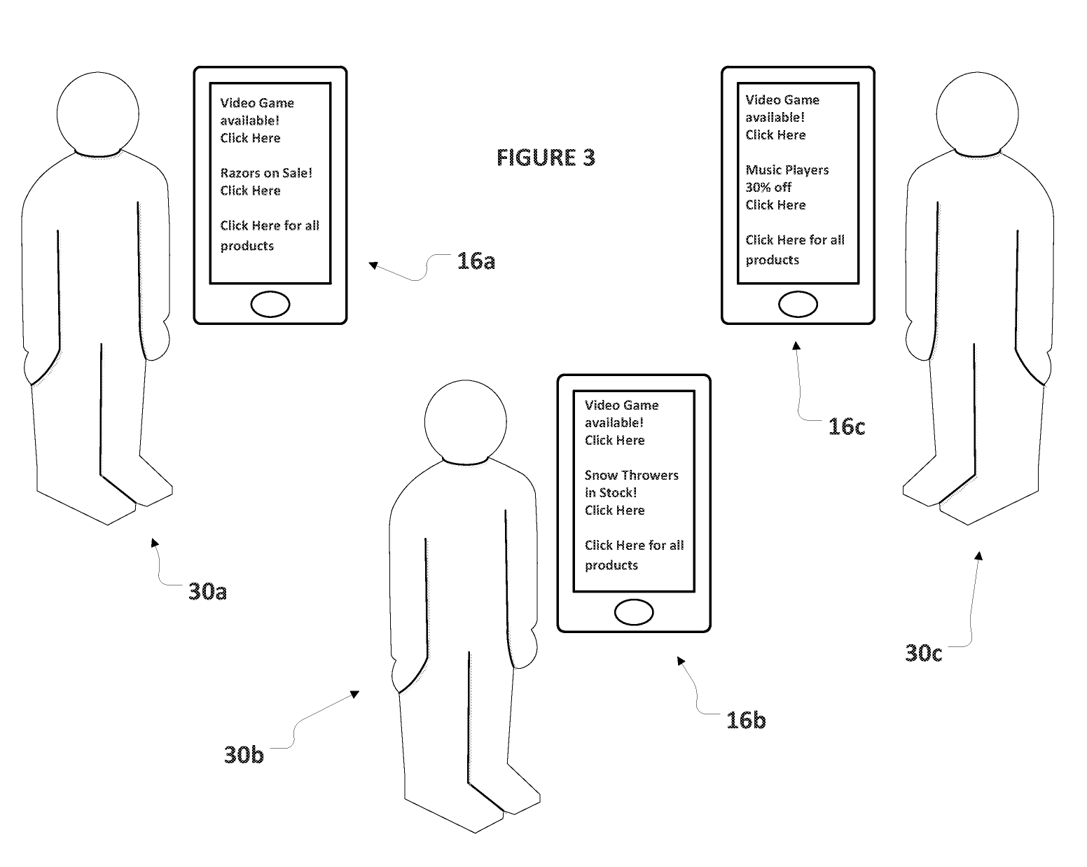

FIG. 3 is an illustration of an operating environment according to some embodiments of the present disclosure. FIG. 3 is an illustration of three consumers 30a, 30b, 30c accessing a retailer's website at generally the same time. It is noted that, while FIG. 3 appears to illustrate that the consumers 30a, 30b, 30c are physically proximate to one another, the consumers 30a, 30b, 30c can be physically remote from one another. Each of the three consumers 30a, 30b, 30c can be operating a respective electronic computing device 16a, 16b, 16c. A product promotion system according to some embodiments of the present disclosure can deliver promotions to each of the three consumers 30a, 30b, 30c.

In the current example, each of the consumers 30a, 30b, 30c can receive a promotion regarding a video game that has been recently been released for sale. Sales data for the previous three hours, or some other predetermined time period, might indicate that the video game is a relatively popular product that appears to be of interest to consumers regardless of time, date, day of the week, or demographic data. The selection module 224 can be configured for any time period to track popularity. Consumer 30a can be a male and receive a second product promotion regarding razors, since consumer 30a has previously purchased razors on the same day of the week as the current day. Consumer 30b can be a consumer in an area receiving snow and receive a second product promotion regarding a snow thrower. Consumer 30c can be a new consumer and can receive a promotion related to music player, a product that is most often placed in the shopping cart at this time of day.

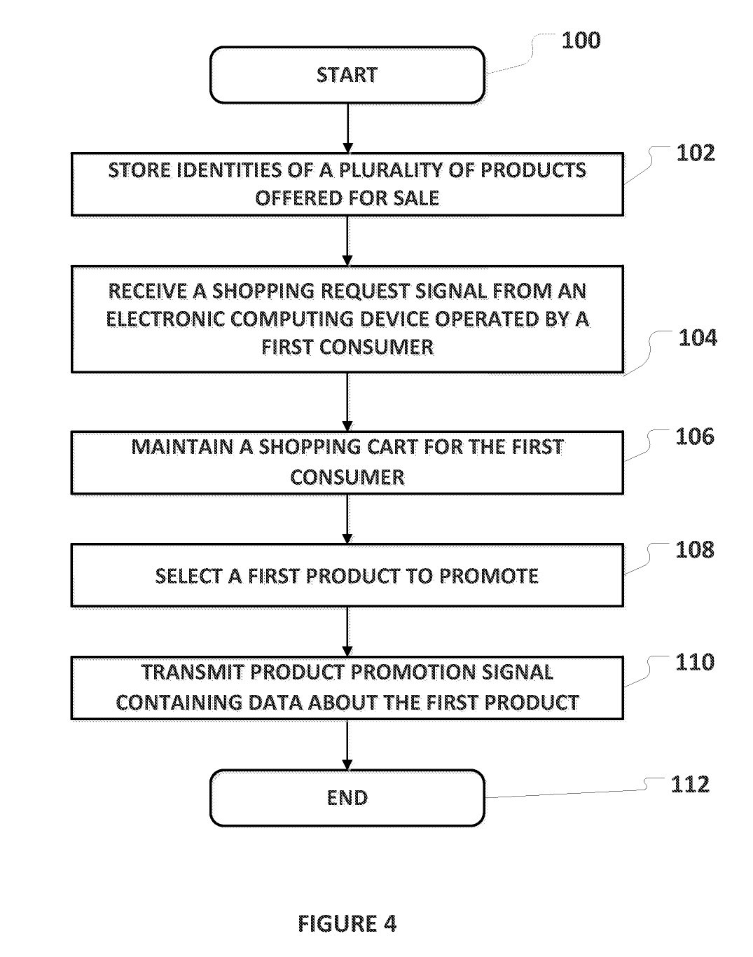

FIG. 4 is a flow chart illustrating a method that can be carried out in some embodiments of the present disclosure. The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

FIG. 4 is a flow chart illustrating a method that can be carried out in some embodiments of the present disclosure. The method can be executed by a commerce server. The commerce server can be located at the retail store or can be remote from the retail store. The method starts at step 100. At step 102, the commerce server can store the identities of a plurality of products offered for sale in a product database. Each identity can be correlated to historical information detailing consumers' interest in the product.

At step 104, the commerce server can receive a shopping request signal from an electronic computing device operated by a first consumer shopping for at least one of the plurality of products offered for sale. At step 106, the commerce server can maintain a shopping cart for the first consumer. One or more of the plurality of products offered for sale can be cataloged for the first consumer until purchase in the shopping cart. At step 108, the commerce server can select a first product to promote to the consumer. The first product can be selected based on historical consumer interest data including previous purchases and past occurrences of a consumer placing products in electronic shopping carts. At step 110, the commerce server can transmit a product promotion signal to the electronic computing device over a network in response to the step of receiving the shopping request signal. The product promotion signal contains data associated with the first product. The exemplary process ends at step 112.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The above description of illustrated examples of the present disclosure, including what is described in the Abstract, are not intended to be exhaustive or to be limitation to the precise forms disclosed. While specific embodiments of, and examples for, the present disclosure are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings of the present disclosure.

What is claimed is:

1. A computer-implemented method comprising:
storing identities of a plurality of products offered for sale in a product database, wherein each identity is correlated to historical information detailing consumers' interest in the product;
receiving, with a processing device of a commerce server, a shopping request signal from an electronic computing device operated by a first consumer shopping for at least one of the plurality of products offered for sale;
maintaining, with the processing device, a shopping cart for the first consumer wherein one or more of the plurality of products offered for sale can be cataloged for the first consumer until purchase;
transmitting, with the processing device, a product promotion signal to the electronic computing device over a network in response to said receiving step, wherein the product promotion signal contains data associated with a first product of the plurality of products offered for sale; and
selecting, with the processing device, the first product for inclusion in the promotion signal in response to the historical information stored in the product database.

2. The computer-implemented method of claim 1 wherein said storing step further comprises:
storing identities of a plurality of products offered for sale in the product database, wherein each identity is correlated to historical information detailing consumers' interest in the product including previous purchases of the product and past occurrences of the product being placed in the shopping cart.

3. The computer-implemented method of claim 2 wherein said storing step further comprises:
storing identities of a plurality of products offered for sale in the product database, wherein each identity is correlated to historical information detailing consumers' interest in the product including purchases of the product and occurrences of the product being placed in the shopping cart, as well as a time of each purchase and occurrence.

4. The computer-implemented method of claim 2 wherein said storing step further comprises:
storing identities of a plurality of products offered for sale in the product database, wherein each identity is correlated to historical information detailing consumers' interest in the product including purchases of the product and occurrences of the product being placed in the shopping cart, as well as a geographic location associated with each purchase and occurrence.

5. The computer-implemented method of claim 2 wherein said storing step further comprises:
storing identities of a plurality of products offered for sale in the product database, wherein each identity is correlated to historical information detailing consumers' interest in the product including purchases of the product and occurrences of the product being placed in the shopping cart, as well as consumer demographic data associated with each purchase and occurrence.

6. The computer-implemented method of claim 2 wherein said storing step further comprises:
storing identities of a plurality of products offered for sale in the product database, wherein each identity is correlated to historical information detailing consumers' interest in the product including previous purchases of the product and past occurrences of the product being placed in the shopping cart occurring within a predetermined period of time prior to said receiving step.

7. The computer-implemented method of claim 6 wherein said storing step further comprises:
storing identities of a plurality of products offered for sale in the product database, wherein each identity is correlated to historical information detailing consumers' interest in the product including previous purchases of the product and past occurrences of the product being placed in the shopping cart occurring within the time period beginning three hours prior to said receiving step.

8. The computer-implemented method of claim 1 wherein said selecting step further comprises:
recognizing, with the processing device, a time of receipt of the shopping request signal;
searching, with the processing device, the product database to identify a current product wherein the current product is the product among the plurality of products most often purchased at the time of receipt; and
defining, with the processing device, the first product as the current product.

9. The computer-implemented method of claim 1 wherein said selecting step further comprises:
recognizing, with the processing device, a time of receipt of the shopping request signal;
searching, with the processing device, the product database to identify a current product wherein the current product is the product among the plurality of products most often placed in a shopping cart at the time of receipt; and
defining, with the processing device, the first product as the current product.

10. The computer-implemented method of claim 1 wherein said selecting step further comprises:
recognizing, with the processing device, a date of receipt of the shopping request signal;
searching, with the processing device, the product database to identify a current product wherein the current product is the product among the plurality of products most often purchased on the date of receipt; and
defining, with the processing device, the first product as the current product.

11. The computer-implemented method of claim 1 wherein said selecting step further comprises:
recognizing, with the processing device, a date of receipt of the shopping request signal;
searching, with the processing device, the product database to identify a current product wherein the current product is the product among the plurality of products most often placed in a shopping cart on the date of receipt; and
defining, with the processing device, the first product as the current product.

12. The computer-implemented method of claim 1 wherein said selecting step further comprises:
recognizing, with the processing device, a time and a date of receipt of the shopping request signal;
searching, with the processing device, the product database to identify a current product wherein the current product is the product among the plurality of products most often purchased on the date of receipt and the time of receipt; and
defining, with the processing device, the first product as the current product.

13. The computer-implemented method of claim 1 wherein said selecting step further comprises:
recognizing, with the processing device, a date and time of receipt of the shopping request signal;
searching, with the processing device, the product database to identify a current product wherein the current product is the product among the plurality of products most often placed in a shopping cart on the date of receipt and at the time of receipt; and
defining, with the processing device, the first product as the current product.

14. The computer-implemented method of claim 1 wherein said step of storing step further comprises:
storing identities of a plurality of consumers in a consumer database, wherein each consumer identity is correlated to historical information detailing that consumer's interest in the products stored in the product database.

15. The computer-implemented method of claim 14 wherein said step of storing identities of a plurality of consumers further comprises:
storing identities of a plurality of consumers in a consumer database, wherein each consumer identity is correlated to historical information detailing that consumer's interest in the products stored in the product database including previous purchases of the product and past occurrences of the product being placed in the shopping cart.

16. The computer-implemented method of claim 15 wherein said selecting step further comprises:
determining, with the processing device, an identity of the first consumer;
recognizing, with the processing device, at least one of a time and a date of receipt of the shopping request signal;
searching, with the processing device, the consumer database to identify a current product wherein the current product is the product most often purchased by the first consumer on the at least one of the date of receipt and the time of receipt; and
defining, with the processing device, the first product as the current product.

17. The computer-implemented method of claim 15 wherein said selecting step further comprises:
determining, with the processing device, an identity of the first consumer;
recognizing, with the processing device, at least one of a time and a date of receipt of the shopping request signal;
searching, with the processing device, the consumer database to identify a current product wherein the current product is the product most often placed in the shopping cart by the first consumer on the at least one of the date of receipt and the time of receipt; and
defining, with the processing device, the first product as the current product.

18. The computer-implemented method of claim 15:
wherein said selecting step further comprises:
determining, with the processing device, an identity of the first consumer;
recognizing, with the processing device, a time and a date of receipt of the shopping request signal;
searching, with the processing device, the consumer database to identify a first current product and a second current product wherein the first current product is the product most often placed in the shopping cart by the first consumer on the date of receipt and the time of receipt and the second current product is the product most often purchased by the first consumer on the date of receipt and the time of receipt; and
defining, with the processing device, the first product as the current product and a second product as the second current product; and
wherein said transmitting step further comprises:
transmitting, with the processing device, the product promotion signal to the electronic computing device over a network in response to said receiving step, wherein the product promotion signal contains data associated with the first product and with the second product.

19. The computer-implemented method of claim 1 further comprising:
determining, with the processing device, if the first consumer will purchase the first product or place the product in the shopping cart without purchasing the product.

20. A computer-implemented method comprising:
storing identities of a plurality of products offered for sale in an product database, wherein each identity is correlated to historical information detailing consumers' interest in the product, wherein consumers' interest includes purchases of the product and occurrences of the product being placed in a shopping cart as well as a time and date of the purchases and the occurrences;
storing identities of a plurality of consumers in a consumer database, wherein each consumer identity is correlated to historical information detailing that consumer's interest in the products stored in the product database including previous purchases of the product and past occurrences of the product being placed in the shopping cart;
receiving, with a processing device of a commerce server, a shopping request signal from an electronic computing device operated by a first consumer shopping for at least one of the plurality of products offered for sale;
maintaining, with the processing device, a shopping cart for the first consumer wherein one or more of the plurality of products offered for sale can be cataloged for the first consumer until purchase;
determining, with the processing device, an identity of the first consumer;
recognizing, with the processing device, a time and date of receipt of the shopping request signal;
searching, with the processing device, the product database to identify a first current product and a second current product wherein the first current product is the product most often placed in a shopping cart by consumers on the date of receipt and the time of receipt and the second current product is the product most often purchased by consumers on the date of receipt and the time of receipt;
searching, with the processing device, the consumer database to identify a third current product and a fourth current product wherein the third current product is the product most often placed in the shopping cart by the first consumer on the date of receipt and the time of receipt and the fourth current product is the product most often purchased by the first consumer on the date of receipt and the time of receipt; and
transmitting, with the processing device, a product promotion signal to the electronic computing device over a network in response to said receiving step, wherein the product promotion signal contains data associated with at least one of the first, second, third, and fourth products.
